(19) United States
(12) Patent Application Publication
(10) Pub. No.: US 2008/0291261 A1
(43) Pub. Date: Nov. 27, 2008

(54) MOBILE TERMINAL AND VIDEO TRANSMISSION METHOD THEREOF

(75) Inventors: Dong Joon PARK, Gumi-si (KR); Soon Shik HWANG, Gumi-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/965,362

(22) Filed: Dec. 27, 2007

(30) Foreign Application Priority Data
May 25, 2007 (KR) 10-2007-0051021

(51) Int. Cl. H04N 7/14

(52) U.S. Cl. 348/14.02

(57) ABSTRACT

A video communication-enabled mobile terminal and video transmission method thereof that are capable of applying various visual effects to a video image transmitted to a counterpart terminal are provided. The video transmission method of a mobile terminal includes establishing a video call according to a video call request and transmitting a transmission video image generated by applying at least one visual effect to a video image.

### CROSS REFERENCE TO THE RELATED APPLICATION

This application claims priority from and the benefit of Korean Patent Application No. 10-2007-0051021, filed on May 25, 2007, which is hereby incorporated by reference for all purposes as if fully set forth herein.

### BACKGROUND OF THE INVENTION

1. Field of the Invention

The present invention relates to a mobile terminal and, in particular, to a video communication-enabled mobile terminal and video transmission method thereof that are capable of applying various visual effects to a video image transmitted to a counterpart terminal.

2. Discussion of the Background

Mobile terminals are portable devices, such as personal mobile communication services terminals, personal digital assistants (PDAs), smart phones, International Mobile Telecommunication 2000 (IMT-2000) terminals, and wireless local area network (WLAN) terminals, that are provided with wireless communication and application programs.

Recent mobile terminals are evolving into multimedia communication devices. A mobile terminal may function as an MP3 player, a digital camera, a global positioning system, or a digital broadcast receiver, and may perform data communication, while maintaining a trim and compact design and tight integration and full functionality of the components. Particularly, with the emerging of a mobile terminal equipped with a digital camera, the mobile terminal may be utilized as portable camera. The still and moving pictures taken with the camera function may be saved and used as a background image of the mobile terminal and transmitted to another mobile terminal.

More recently, the camera function of the mobile terminal has become more sophisticated and may support real-time video communication.

Typically, a video communication session is performed in such a manner that a mobile terminal establishes a video call session in response to a video call request received from a counterpart terminal and the two terminals exchange the images taken with their cameras in real time.

However, the conventional video communication-enabled mobile terminal has a drawback in that all the images taken by its camera, even the images that the user does not want to be transmitted, may be transmitted during the video communication session regardless of user intention.

Also, the conventional video communication-enabled mobile terminal may not allow image processing settings to be changed. Therefore, the images to be transmitted are processed with the same process settings regardless of the recipients, which may limit the user's ability to express taste or emotional circumstances with visual effects.

### SUMMARY OF THE INVENTION

The present invention provides a video communication-enabled mobile terminal and video transmission method thereof that are capable of applying various visual effects to the video image to be transmitted during a video communication session.

The present invention also provides a video communication-enabled mobile terminal and video transmission method thereof that are capable of processing transmission video images adaptive to counterpart call ID.

Additional features of the invention will be set forth in the description which follows, and in part will be apparent from the description, or may be learned by practice of the invention.

The present invention discloses a video communication method for a mobile terminal including establishing a video call according to a video call request, and transmitting a transmission video image generated by applying at least one visual effect to a video image.

The present invention also discloses a mobile terminal having a video communication function. The mobile terminal includes a camera unit to take a video image, a visual effect application unit to generate a transmission video image by applying at least one of various visual effects to the video image during a video communication session, and a transmission unit to transmit the transmission video image.

The present invention also discloses a method for configuring a visual effect for a contact entry in a mobile terminal, including receiving a visual effect configuration request, displaying a list of contact entries, selecting the contact entry, and selecting a visual effect for the contact entry.

It is to be understood that both the foregoing general description and following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a mobile terminal according to an exemplary embodiment of the present invention.

FIG. 2 is a table showing a visual effect database (visual effect DB) for a video transmission method according to an exemplary embodiment of the present invention.

FIG. 3 is a flowchart showing a visual effect configuration procedure of a video transmission method according to an exemplary embodiment of the present invention.

FIG. 4A, FIG. 4B, and FIG. 4C are screen images showing steps of visual effect configuration procedure of FIG. 3.

FIG. 5 is a flowchart showing a video call processing procedure of a video transmission method according to an exemplary embodiment of the present invention.

FIG. 6A, FIG. 6B, and FIG. 6C are screen images showing steps of video call processing procedure of FIG. 5.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of different components may be exaggerated for clarity. Like reference numerals in the drawings denote like elements.

In the following, the term “mobile terminal” covers any terminal having video processing and transmission capability, such as a digital multimedia broadcasting receiver (DMB), a Digital Video Broadcasting-Handheld (DVB-H) receiver, a corded phone, a cordless phone, a laptop computer, a personal computer, a 3^{rd} generation (3G) terminal including Wideband Code Division Multiple Access (WCDMA) terminals, a Global System for Mobile Communication (GSM) terminal, a General Packet Radio System (GPRS) terminal, and their equivalents.

In the following, the term “video data” refers to data obtained by d an image taken by a camera module. The video data may be raw data or compressed data.

The term “transmission video data” refers to video data obtained by resizing and changing a frame rate and applying at least one visual effect.

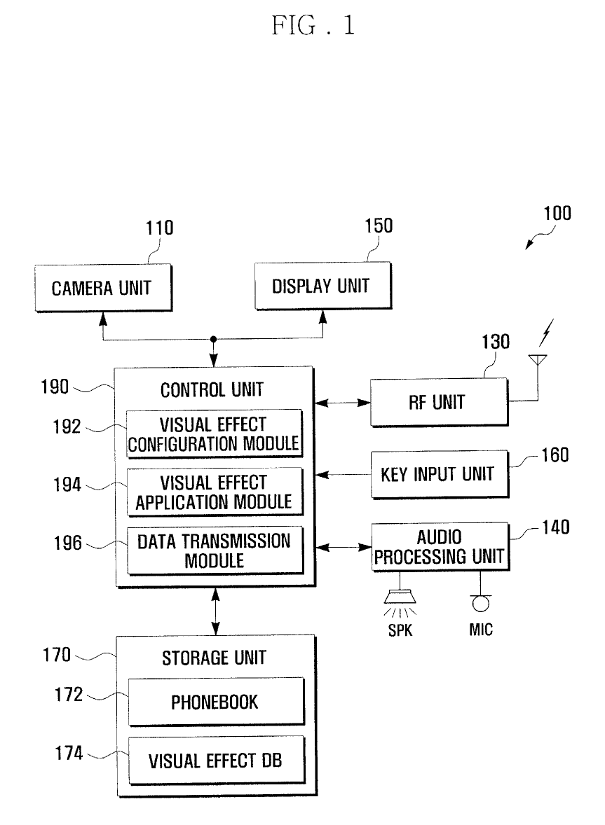

Referring to FIG. 1, the mobile terminal 100 includes a camera unit 110, a radio frequency (RF) unit 130, an audio processing unit 140, a display unit 150, a key input unit 160, a storage unit 170, and a control unit 190.

The camera unit 110 captures an image and generates video data from the captured image. The video data is transferred to the control unit 190. The camera unit 110 includes an image sensor (not shown) to convert optical signals into electrical signals and a signal processor (not shown) to convert the electrical signals into digital data. The image sensor can be a Charge Coupled Device (CCD) and the signal processor can be a Digital Signal Processor (DSP). However, other types of image sensors and signal processors can be used.

Although not shown in the figures, the camera unit 110 may include a video processing unit. The video processing unit processes each frame of the video signal and outputs video data according to the size and characteristics of the screen of the display unit 150. The video data may be compressed by the video processing unit and then transferred to the control unit 190. The video processing unit may include a codec to compress the video data and decompress the compressed video data. The video codec may include at least one of a JPEG, a Wavelet, an MPGE2, an MPEG4, an H.263, and an H.264.

The RF unit 130 is responsible for radio communication of the mobile terminal 100 with a base station. The RF unit 130 includes an RF transmitter to up-convert and amplify the transmission signal and an RF receiver to low-noise-amplify and down-convert the received signal. The RF unit 130 also transfers the data extracted from the received signal to the control unit 190 and transmits the data output by the control unit 190 in the form of a radio frequency.

The audio processing unit 140 may include a codec. The codec may include a data codec to process packet data and an audio codec to process an audio signal including a voice signal. The audio processing unit converts the digital audio data processed by the control unit 190 into analog signals using the audio codec and outputs the analog signals in the form of audible sound wave through a speaker, and converts analog audio signals that are input through a microphone into digital audio data.

The display unit 150 displays menu, settings, and communication status screens associated with various applications. For example, the display unit 150 may include a liquid crystal display (LCD). In this case, the display unit 150 may include a controller, a video memory to store video data, and LCD devices.

In more detail, the display unit 150 may be provided with an LCD panel (not shown) and a backlight unit (not shown). The LCD panel includes a pair of glass substrates with liquid crystal molecules filled in a narrow gap between the two substrates. The backlight unit is located behind the LCD panel. Each liquid crystal cell acts as an electro-optical switch that controls the light transmission from the backlight unit according to a signal applied to a signal electrode such that a color can be determined according to the transmissivity. If the LCD panel of the display unit 150 has a touch screen, the display unit 150 may act as a part of the key input unit 160.

The key input unit 160 receives a user manipulation signal and outputs a corresponding sequence to the control unit 190. The key input unit includes a plurality of function keys (not shown) to control various functions and a plurality of alphanumeric keys (not shown) to input numbers and letters.

The storage unit 170 may include a program region to store application programs associated with specific functions of the mobile terminal 100 and a data region to store user data generated while executing the application programs.

In more detail, the program region stores an operation system (OS) and application programs, such as a multimedia player and image viewer programs. If a specific function is requested, the control unit 190 activates an application program associated with the function. The storage unit 170 includes at least one buffer to buffer user data, such as audio files and still and moving picture files, generated during the operation of the application program.

The data region stores the user data generated by the application programs as well as downloaded contents such as audio and video files.

Particularly, the data region of the storage unit 170 stores a database including a phonebook 172 and a visual effect database (visual effect DB) 174 to manage visual effects set for respective contact entries in the phonebook 172.

The phonebook 172 is a collection of contact entries that each includes a few fields, such as a name field, a phone number field, and an email address field. Each contact entry may be input by the user, extracted from an incoming call, or downloaded from a web server.

The visual effect DB 174 is a collection of visual effects to be selectively applied to video data in association with the contact entries listed in the phonebook 172.

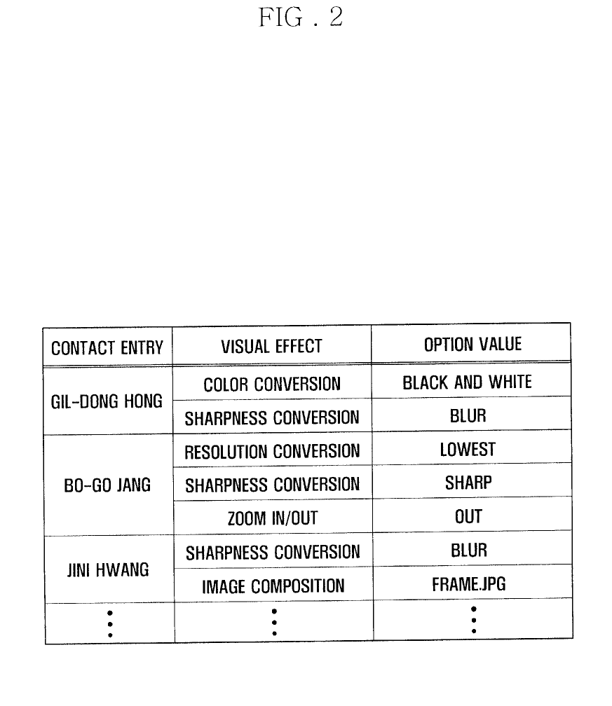

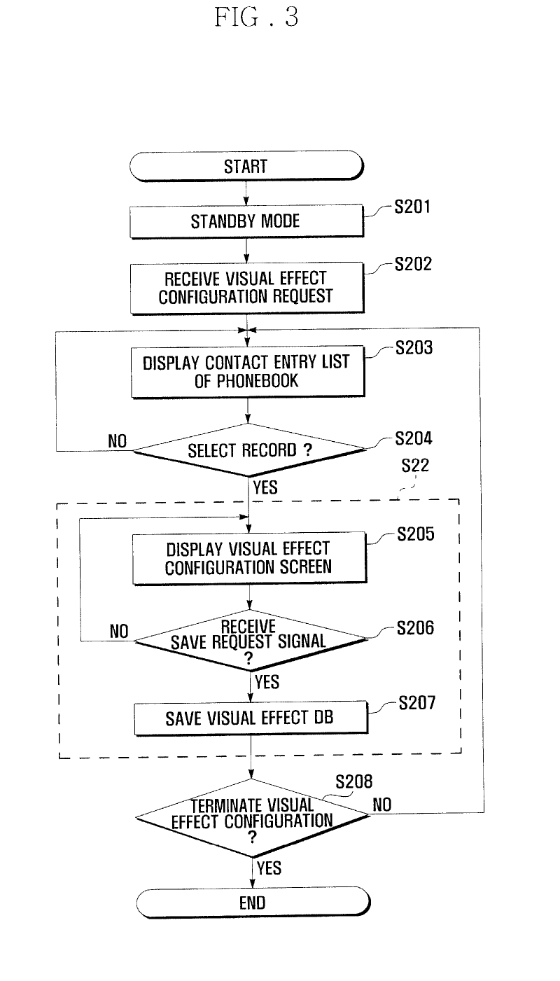

Referring to FIG. 2, the visual effect DB 174 includes a contact entry field, a visual effect field, and an option value field.

The contact entry field lists names selected from the phonebook 172.

The visual effect field contains the visual effects to be applied to the video data transmitted to the corresponding contact entries. The visual effect may be a special effect for rendering a video image. There are several visual effects such as zoom in/out, color conversion, sharpness conversion, brightness conversion, image composition, filtering, and resolution conversion.

The option field includes option values, each of which is an application degree of the corresponding visual effect. For example, a member may be assigned a color conversion effect with an application degree of “black and white.”

Although structured with the three fields including the contact entry field, the visual effect field, and the option value field in FIG. 2, the visual effect DB 174 may include more or less than 3 fields. Also, the option values of each visual effect may be more finely classified. Also, more than one visual effect may be set for a contact entry using an application time field that provides for different visual effects to be applied to the video image as time advances.

The control unit 190 controls the general operations of the mobile terminal and signaling among the components. That is, the control unit 190 controls the cooperative signaling of the camera unit 110, the RF unit 130, the audio processing unit 140, the display unit 150, the key input unit 160, and the storage unit 170.

The control unit 190 executes functions of the mobile terminal 100 in response to the signal input through the key input unit 160 and displays the execution status and information of the functions on the display unit 150.

The control unit 190 also applies the visual effect set for a contact, i.e. the value of the visual effect DB 174 that corresponds to the contact entry of the contact, to the video image that is to be transmitted to the contact's counterpart terminal during the video communication session. In order to effectively process the video data, the control unit 190 includes a visual effect configuration module 192, a visual effect application module 194, and a video data transmission module 196.

The visual effect configuration module 192 performs visual effect configuration. That is, the visual effect configuration module 192 selects a name from the phonebook 172 and configures a visual effect entry corresponding to the contact entry and option value entry of the visual effect in response to user commands. The configuration is registered with the visual effect DB 174.

When a video communication session is established, the visual effect application module 194 checks a visual effect set for the contact entry of the counterpart terminal and applies the visual effect to the video image to generate transmission video data.

The video data transmission module 196 transmits the transmission video data to the counterpart terminal.

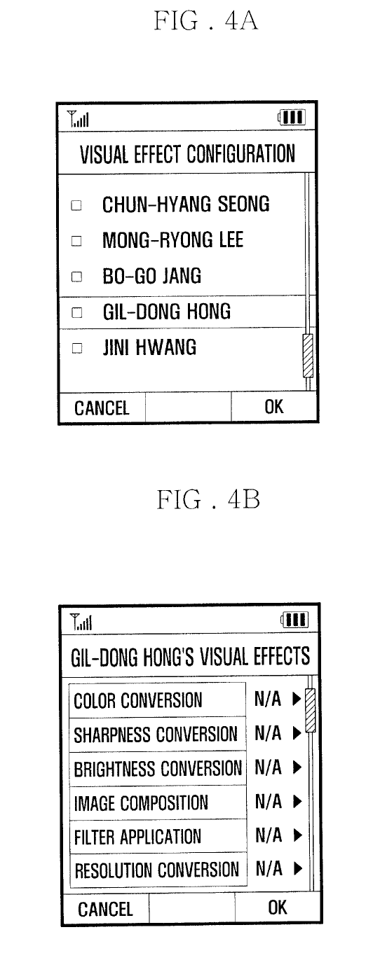

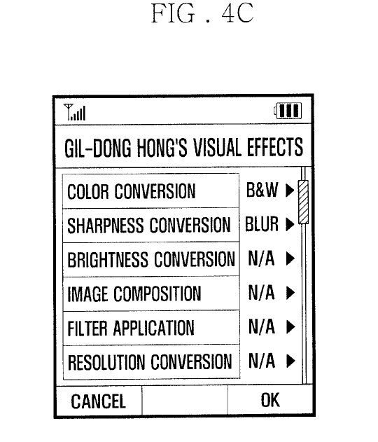

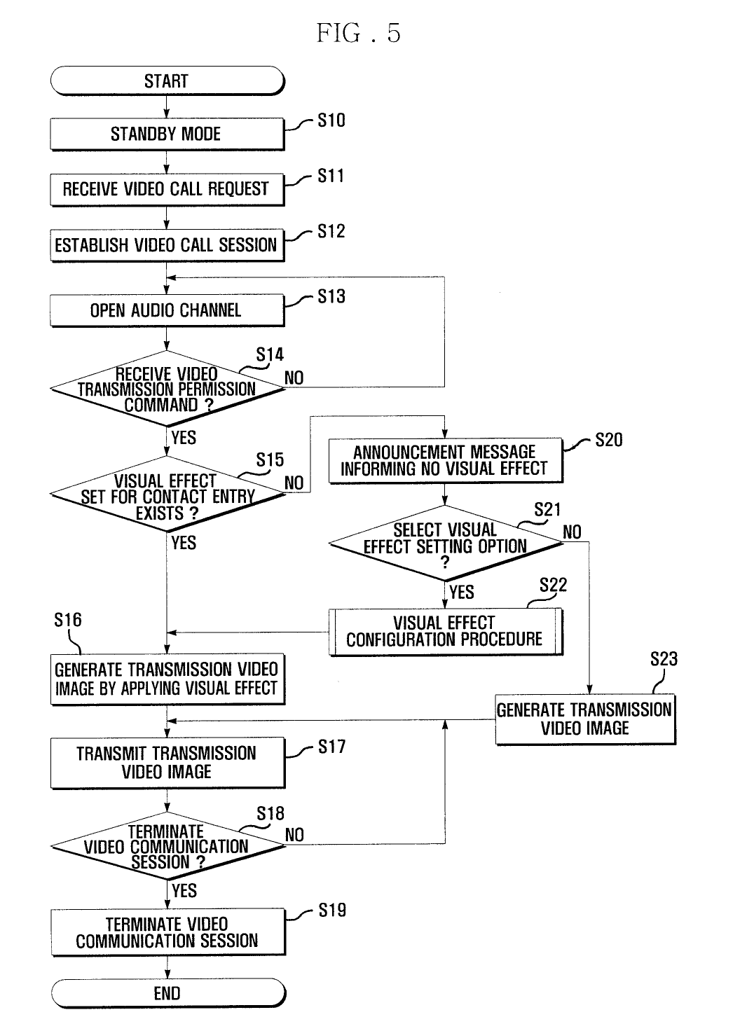

Referring to FIG. 1, FIG. 2, FIG. 3, FIG. 4A, FIG. 4B, and FIG. 4C, if the power is switched on, the mobile terminal 100 enters a standby mode (S201). If a visual effect configuration request is input through the key input unit 160, the visual effect configuration module 192 of the control unit 190 recognizes the visual effect request (S202) and displays a list of names registered in the phonebook (S203), as shown in FIG. 4A.

Next, the control unit 190 determines whether a contact entry (for example, Gil-dong Hong) is selected from the list, i.e. a record is selected from the phonebook table (S204) while the list is displayed. If a contact entry is selected, the control unit 190 displays a visual effect configuration screen (S205), as shown in FIG. 4B.

The visual effect configuration screen presents all available visual effects, such that the user can assign one or more of the visual effects for the selected contact entry.

In this exemplary embodiment, the mobile terminal provides several visual effects including a size conversion effect to change the size of an image, a color conversion effect to change the saturation degree of the image, a blur effect to change the sharpness of the image, a brightness conversion effect to change the brightness of the image, an image composition effect to mix at least two images, a filtering effect to apply various filters, such as a smog filter and a sepia filter, and a resolution conversion effect to change the resolution of the image. Of course other visual effects not listed above may be included for the video transmission method of exemplary embodiments of the present invention.

While the visual effect configuration screen is displayed, at least one visual effect and its option value may be highlighted and selected in response to user selection command. In this exemplary embodiment, the color conversion effect with an option value entry of “B&W” (i.e., black and white) and the sharpness conversion effect with an option value entry of “blur” are selected for the contact entry “Gil-dong Hong,” as shown in FIG. 4C.

Next, the control unit 190 determines whether a save request signal is detected (S206). If a save request signal is detected, the control unit 190 saves the visual effect DB 174 with the visual effect settings (S207). If a save request is not detected, the control unit 190 continues to display the visual effect configuration screen (S205).

Accordingly, the contact entry “Gil-dong Hong” is registered to have the visual effect DB 174, which includes the black and white effect and the blur effect. Although the visual effect DB 174 is stored separately from the phonebook 172 in this exemplary embodiment, the visual effect DB 174 may be integrated into the phonebook 172.

After storing the visual effect configuration, the visual effect configuration module 192 determines whether to end the visual effect configuration on the basis of key input by the user (S208).

If a key input to continue the visual effect configuration is detected, the visual effect configuration module 192 repeats step S203.

On the other hand, if a key input to terminate the visual effect configuration is detected, the visual effect configuration module 192 finishes the visual effect configuration and the mobile terminal enters the standby mode.

Although FIG. 3 is depicted only with new record registration steps, the visual effect configuration procedure may be provided with record editing and deletion steps.

The visual effects configured as above may be applied to the video data transmitted to the counterpart terminal corresponding to the contact entry involved in a video communication session.

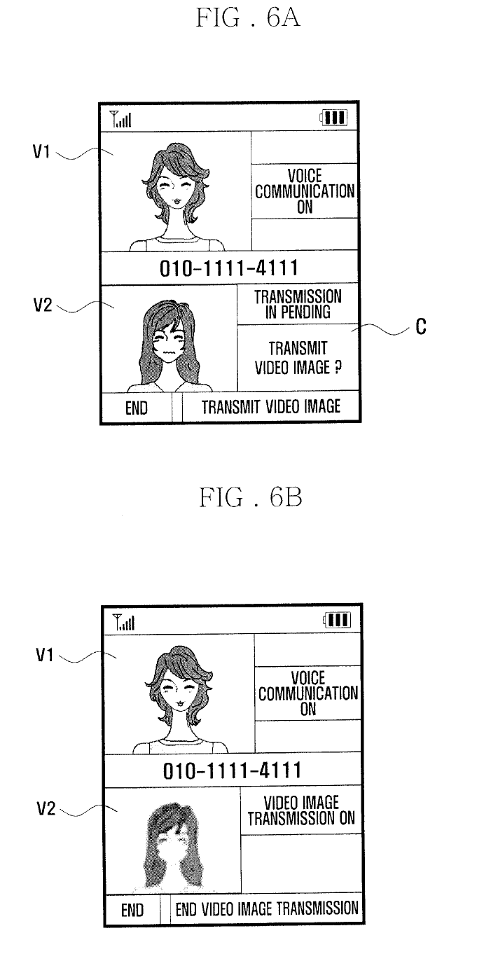

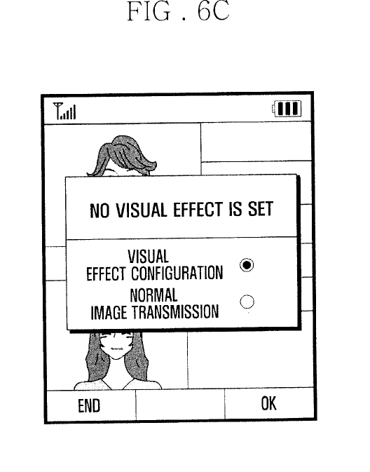

Referring to FIG. 1, FIG. 2, FIG. 5, FIG. 6A, FIG. 6B, and FIG. 6C, if the power is switched on, the mobile terminal enters a standby mode (S10) and the control unit 190 detects a video call request signal (S11). The video call request signal may be generated in response to an outgoing video call request or an incoming video call request.

In the case of an outgoing video call, the video call request signal is generated when a phone number and a call key are sequentially input through the key input unit 160 in a video call mode. In the case of an incoming video call, the video call request signal is generated when an incoming video call is received from a counterpart terminal.

If a video call request signal is received, the control unit 190 performs a video call session establishment process (S12). When an incoming video call is received, a video call session is established in response to a call key input. Similarly, in the case of an outgoing call, the video call session is established when a video call establishment request signal is received from the counterpart terminal.

In this exemplary embodiment, the mobile terminal 100 transmits a voice signal but not video data even when the video call session is established. That is, the control unit 190 opens only an audio channel (S13) and activates the camera unit 110 simultaneously at the beginning of the video call session. Although not shown in FIG. 5, if an end key is input while only the audio channel is open, the control unit 190 ends the video call session.

After opening the audio channel, the control unit 190 determines whether to transmit the video data captured by the camera unit 110 on the basis of user input (video transmission permission command) (S14). At this time, the control unit 190 displays a communication status screen presenting the image taken by the camera unit 110 with a video image transmitted by the counterpart terminal as shown in FIG. 6A.

As shown in FIG. 6A, the communication status screen presents a first video image V1 received from the counterpart terminal and a second video image V2 taken by the camera unit 110. At this time, the counterpart terminal receives only the voice signal and therefore, does not receive the second video image V2.

The communication status screen is also provided with an announcement message C asking whether to approve transmission of the second video image V2.

If the transmission of the second video image V2 is rejected, the control unit 190 keeps the video channel closed. That is, the video image taken by the camera unit 110 is transmitted only when the user permits the transmission even in the video communication session. Therefore, it may be possible to prevent information regarding a place or a situation from being unintentionally exposed to the recipient.

If a key input to allow the transmission of the second video image V2 is detected, the visual effect application module 194 of the control unit 190 checks for a contact entry corresponding to the counterpart user (in this exemplary embodiment, Gil-dong Hong) and determines if the contact entry is registered to the visual effect DB 174 with at least one visual effect (S15). If the there is a corresponding contact entry registered to the visual effect DB 174, the visual effect application module 194 generates a transmission video image by applying the visual effect to the second video image V2 (S16). That is, the visual effect application module 194 applies the at least one visual effect registered with the contact entry to the video image taken by the camera module 110.

Assuming that the corresponding contact entry is Gil-dong Hong listed in the visual effect DB of FIG. 2, the visual effect application module 194 converts the video image into a black and white image by applying the color conversion effect and blurs the black and white image by applying the sharpness conversion effect, resulting in generation of transmission video image V2 as shown in FIG. 6B.

Of course, additional visual effect such as image resizing may be applied to the blurred image.

The transmission video image generated in such manner is transmitted to the counterpart terminal, i.e. Gil-dong Hong's terminal (S17). Accordingly, the counterpart user Gil-dong Hong can see the video image rendered with the visual effects.

The transmission video image generation can be accomplished such that different visual effects are applied to the video image over time.

During the video communication session, the control unit 190 determines whether a session termination request signal is detected (S18). The session termination request signal can be received from the counterpart terminal or by user input.

If a session termination request signal is detected, the control unit 190 ends the visual communication session (S19).

If it is determined that the contact entry of the counterpart user is registered with the visual effect DB 174 with no visual effects at step S15, the visual effect application module 194 displays a popup window announcing no visual effect is set for the contact entry as shown in FIG. 6C (S20). The popup window also provides the options “visual effect configuration” and “normal image transmission.”

While displaying the popup window, the visual effect application module 194 determines whether key input to select one of the options is detected (S21).

If a key input to select the visual effect configuration option is detected, the visual effect configuration module 192 performs a visual effect configuration procedure (S22) that is identical to steps S205, S206, and S207 of FIG. 3.

After the visual effect configuration procedure finishes, the video data transmission module 196 transmits the transmission video image generated at step S22 (S16, S17, S18, and S19).

If a key input to select the “normal image transmission” option is entered, the visual effect module 194 generates the transmission video image by resizing and changing frame rate without applying any visual effects (S23). The transmission video image is transmitted through the steps S17, S18, and S19.

As described above, the mobile terminal and video transmission method of the exemplary embodiments of the present invention may allow preset visual effects to be applied to the video image and may selectively apply a visual effect during a video communication session such that a user can transmit the video image rendered as he/she wants. Also, the video transmission method of the exemplary embodiments of the present invention allows the user to register specific visual effects per contact entry of a phonebook. Therefore, it may be possible to transmit the video image rendered adaptive to the contact entry.

Although the video data transmission is performed with the user permission, the user permission process can be omitted. That is, the video transmission method can be modified such that video image taken by the camera unit is automatically processed, if the recipient user is registered with a visual effect, using the visual effect and, otherwise, without visual effect, after the voice channel is open.

Although the transmission video image is generated and transmitted after the voice channel is open in the above exemplary embodiment, the present invention is not limited thereto. For example, the voice and video channels can be open simultaneously after the transmission video image is generated.

Although the video transmission method of the above exemplary embodiment is explained only with the visual effect application to the video image taken by the camera unit, the present invention is not limited thereto. For example, exemplary embodiments of the present invention may be applied to the audio processing method in which audio data are rendered by applying various sound effects. Also, the visual effect may be applied to various types of image files stored in the storage unit.

Although the video transmission method is explained with a mobile terminal in the above exemplary embodiment, the present invention is not limited thereto. For example, the video transmission method can be applied to various electronic devices having an image display function.

As described above, the mobile terminal and video transmission method thereof according to exemplary embodiments of the present invention may allow at least one visual effect to be applied to an image to be transmitted to a recipient during a video communication session. Therefore, it may be possible to transmit the video image carrying taste or emotional circumstance of the user. Also, the video transmission method of the exemplary embodiments of the present invention allows at least one visual effect to be assigned to each contact entry such that video images can be rendered with different visual effects by recipients.

Furthermore, the mobile terminal of the exemplary embodiments of the present invention transmits video data captured by a camera module only when the user permits transmission even when the video communication session begins, which may prevent information regarding a place or a situation from being exposed to a counterpart user.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A video communication method for a mobile terminal, comprising:
establishing a video call according to a video call request; and
transmitting a transmission video image generated by applying at least one visual effect to a video image.

2. The video communication method of claim 1, further comprising assigning at least one of various visual effects to a contact entry stored in the mobile terminal before establishing the video call.

3. The video communication method of claim 2, wherein transmitting the transmission video image comprises:
opening an audio channel to transmit a voice signal; and
opening a video channel to transmit the transmission video image in response to a video transmission command.

4. The video communication method of claim 3, wherein opening the video channel comprises:
receiving the video transmission command;
determining whether the at least one visual effect is set for the contact entry involved in the video call;
applying the at least one visual effect to the video image if at least one visual effect is set for the contact entry.

5. The video communication method of claim 4, wherein opening the video channel further comprises:
determining whether a user command for configuring a visual effect for the contact entry is entered if the at least one visual effect is not set for the contact entry; and
setting the at least one visual effect for the contact entry.

6. The video communication method of claim 5, wherein applying setting the at least one visual effect comprises:
displaying a visual effect setting screen in response to the user command; and
assigning the at least one visual effect for the contact entry.

7. The video communication method of claim 2, wherein assigning at least one of various visual effects to a contact entry comprises:
displaying a visual effect setting screen with a list of contact entries in response to a user command; and
selecting a contact entry from the list in response to a user command; and
setting the at least one visual effect for the selected contact entry.

8. The video communication method of claim 2, wherein the various visual effects comprise a frame resizing effect, a color conversion effect, a sharpness conversion effect, a bright conversion effect, an image composition effect, a filter application effect, and a resolution conversion effect.

9. The video communication method of claim 2, wherein transmitting the transmission video image comprises:
applying the at least one visual effect to the video image to generate a transmission video image in response to a user commander; and
transmitting a voice signal and the transmission video image simultaneously.

10. A mobile terminal having a video communication function, comprising:
a camera unit to take a video image;
a visual effect application unit to generate a transmission video image by applying at least one of various visual effects to the video image during a video communication session; and
a transmission unit to transmit the transmission video image.

11. The mobile terminal of claim 10, further comprising a visual effect configuration unit to assign the at least one of various visual effects to contact entries stored in the mobile terminal.

12. The mobile terminal of claim 11, further comprising a storage unit to store information on the contact entries and parameters associated with the at least one of various visual effects assigned by the visual effect configuration unit.

13. The mobile terminal of claim 11, wherein the visual effects comprise a frame resizing effect, a color conversion effect, a sharpness conversion effect, a bright conversion effect, an image composition effect, a filter application effect, and a resolution conversion effect.

14. A method for configuring a visual effect for a contact entry in a mobile terminal, comprising:
receiving a visual effect configuration request;
displaying a list of contact entries;
selecting the contact entry; and
selecting a visual effect for the contact entry.

15. The method of claim 14, wherein selecting a visual effect for the contact entry comprises:
displaying a visual effect configuration screen;
receiving a save request signal; and
saving the visual effect in a visual effect database.
